(19) United States
(12) Patent Application Publication
(10) Pub. No.: US 2020/0272253 A1
(43) Pub. Date: Aug. 27, 2020

(54) PRESSURE SENSING MOUSE

(71) Applicant: Waltop International Corporation, HSINCHU CITY (TW)

(72) Inventors: WEN-CHI CHEN, Taichung City (TW); YING-HWA TANG, Hsinchu City (TW); CHIA-JUI YEH, Hsinchu (TW)

(21) Appl. No.: 16/791,018

(22) Filed: Feb. 14, 2020

(30) Foreign Application Priority Data
Feb. 27, 2019 (TW) 108106763

(51) Int. Cl. G06F 3/0354; G06F 3/038; A63F 13/24

(52) U.S. Cl. CPC G06F 3/03543; G06F 2203/0384; A63F 13/24; G06F 3/0383

(57) ABSTRACT

A pressure sensing mouse including a pressure plate, a main body, a chassis, a main circuit board, and a pressure sensing component disposed on the main circuit board is provided. A central portion of an inner side of the pressure plate extends downwardly to provide a pressure spring element that is in direct contact with the pressure sensing component throughout the main body. The pressure sensing mouse is used in a software game for a tapping force type. When the user taps the pressure sensing mouse with the palm of a hand, an object in a corresponding software game will correspondingly generate a pressed game display result in the screen, therefore, better gaming experiences can be provided for users.

### CROSS-REFERENCE TO RELATED PATENT APPLICATION

This application claims the benefit of priority to Taiwan Patent Application No. 108106763, filed on Feb. 27, 2019. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a pressure sensing mouse, and more particularly to a pressure sensing mouse used in a software game utilizing tapping force.

### BACKGROUND OF THE DISCLOSURE

In the current technology, there are diverse and different kinds of computer mouse product items that include many different functions. However, a mouse capable of sensing a tapping force performed by the palm of a user as controls in a software game utilizing tapping force is difficult to find.

Accordingly, it is necessary to design a mouse that can control the motion of an on-screen object in the software game according to the tapping action from the palm of the user, so that different types of input controls can be applied to a computer game to provide flexible and diversified control methods. As a result, the computer game would seem more realistic and interesting, thereby providing a better gaming experience to users thereof.

### SUMMARY OF THE DISCLOSURE

The present disclosure provides a pressure sensing mouse. In response to the above-referenced technical inadequacies, a pressure sensing mouse capable of detecting a tapping action performed by a user is provided. When the tapping action from the user is detected, a tapping force is applied on an object in a software game and the object will correspondingly be pressed down. As a result, the software game would seem more realistic and interesting, thereby providing a better gaming experience to users thereof.

To achieve the foregoing objective, one of the main objectives of the present disclosure is to provide a pressure sensing mouse. The pressure sensing mouse includes a pressure plate, a main body, a chassis, a main circuit board, and a pressure sensing component disposed on the main circuit board. A central portion of an inner side of the pressure plate extends downwardly to provide a pressure spring element that is in direct contact with the pressure sensing component throughout the main body. The pressure sensing mouse in the present disclosure is used in a software game utilizing tapping force. When the user taps the pressure sensing mouse with the palm of a hand, the object in the corresponding software game will correspondingly be pressed down on the screen. The present disclosure can provide a better gaming experience for users.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 shows a transparent schematic view in one embodiment of the present disclosure.

FIG. 2 shows an exploded schematic view in one embodiment of the present disclosure.

FIG. 3 shows a schematic view of bottom elements in one embodiment of the present disclosure.

FIG. 4 shows a schematic view of a connection between a main circuit board and tap-sensitive circuit blocks in the present disclosure.

FIG. 5 shows a schematic view a tapping force being utilized in a software game in the embodiment of the present disclosure.

FIG. 6 shows a curved schematic view of the pressure plate in the embodiment of the pressure disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

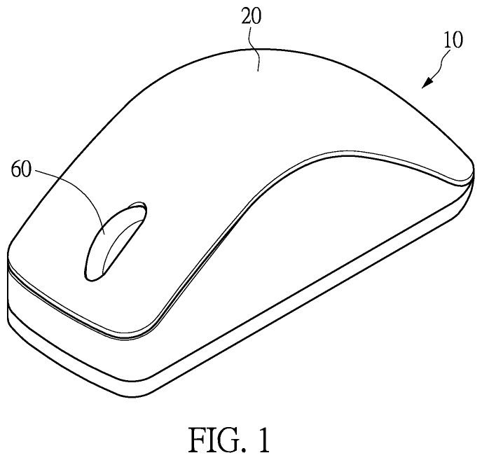

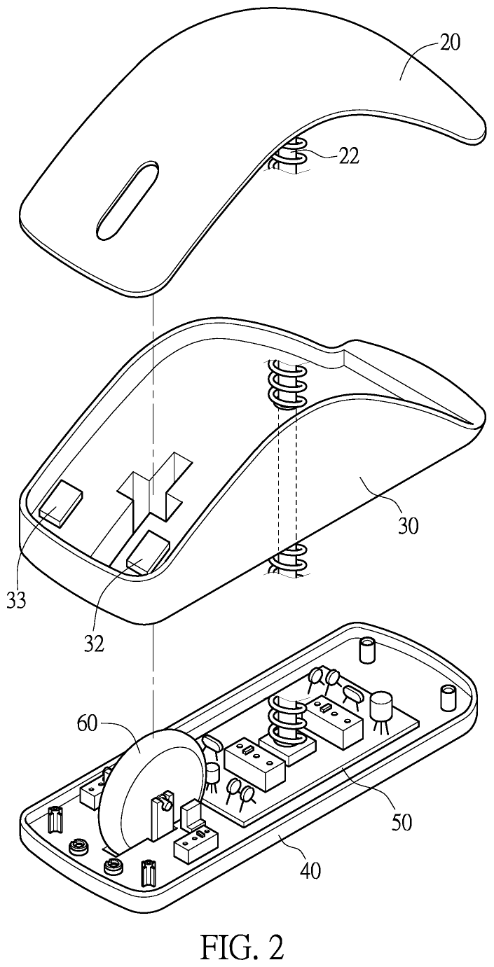

With reference to FIG. 1 and FIG. 2, a pressure sensing mouse 10 in one embodiment of the present disclosure is mainly used in a software game utilizing tapping force. The pressure sensing mouse 10 includes a pressure plate 20, a main body 30, a chassis 40, a main circuit board 50, and a pressure sensing element 24. A pressure spring element 22 extends downward from a central portion inside of the pressure plate 20. The pressure spring element 22 penetrates the main body 30 and directly contacts the pressure sensing element 24. The main body 30 is disposed below the pressure plate 20 to carry the pressure plate 20. A left button switch 32 and a right button switch 33 are respectively disposed on a front side of the main body 30, and a wheel 60 is disposed at the central portion of the front side of the main body 30. The chassis 40 is disposed below the main body 30 to carry the main body 30, and the chassis 40 is assembled with the main body 30 as the bottom of the pressure sensing mouse 10. The main circuit board 50 is disposed above the chassis 40 and is covered by the main body 30. In other words, the main circuit board 50 is disposed inside the main body 30 and disposed on the chassis 40.

The main circuit board 50 in the present disclosure is the main control circuit in the pressure sensing mouse 10, and is electrically coupled to the left button switch 32 and the right button switch 33. Therefore, the functions of a left mouse button and a right mouse button of a general mouse are included in the main circuit board 50. In practical applications, a plate surface in the aforementioned pressure plate 20 is integrally formed, and a left side and a right side at the front end of the pressure plate 20 can be pressed to contact the left button switch 32 and the right button switch 33 respectively. The left switch 32 contacts the bottom of a left front end of the pressure plate 20 and the right button 33 contacts the bottom of a right front end of the pressure plate 20, so that the left front end and the right front end of the pressure plate 20 have the functions of the left mouse button and the right mouse button respectively. The two sides at the front end of the pressure plate 20 have the functions of the left button and the right button of the mouse. In addition, the main circuit board 50 can also read encoded information of the wheel 60, and the main circuit board 50 also includes a wheel switch encoder which is able to detect a mouse movement signal and read the signal of coordinates of the mouse movement.

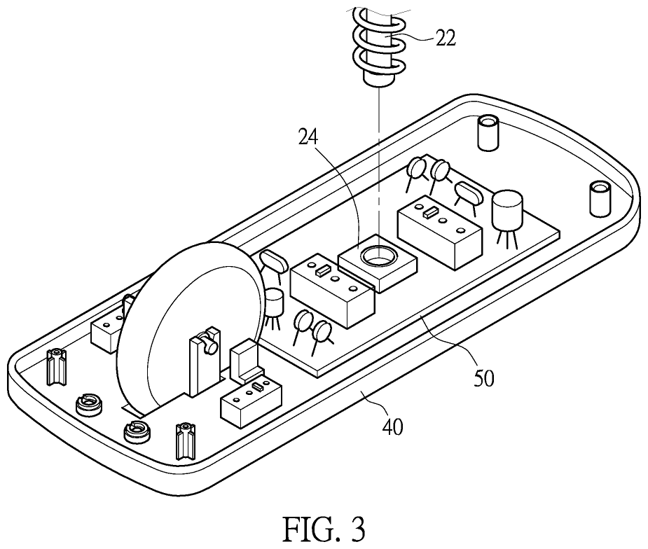

With reference to FIG. 3, the pressure sensing element 24 is disposed on the main circuit board 50 and is electrically connected to the main circuit board 50. The pressure spring element 22 provided at the bottom of the pressure plate 20 penetrates the main body 30 and directly contacts the pressure sensing element 24. Accordingly, when the pressure plate 20 is pressed, the pressure plate 20 will contact the pressure sensing element 24. When the pressure sensing element 24 detects a tapping action from a user, the action is sensed and transmitted to the main circuit board 50. Further, when the pressure sensing element 24 detects the downward tapping action, strength and speed of the pressure plate 20, a mouse output signal is generated by the main circuit board 50 in the pressure sensing mouse 10 and transmitted to a computer connected to the pressure sensing mouse 10. The main job for the computer is to execute the operation of the tapping action in the software game. When the user taps the pressure plate 20, an object on the screen of the computer will correspondingly be pressed downward. Because of the tapping action on the pressure plate 20, the object will be pushed down on the screen at the proper time, speed, and force.

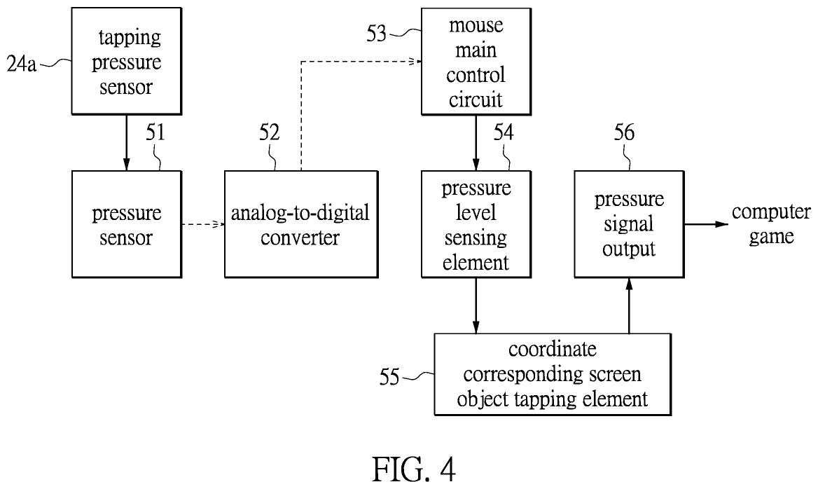

With reference to FIG. 4, the main circuit board 50 in the present disclosure not only includes the control circuit corresponding to a left mouse button, a right mouse button, and wheel encoding information, but also includes a tapping pressure sensor 24a, a pressure sensor 51, a mouse main control circuit 53, a pressure level sensing element 54, a coordinate corresponding screen object tapping element 55, and a pressure signal output 56. The tapping pressure sensor 24a is coupled to the pressure sensing element 24 to detect and determine the tapping action performed on the pressure plate 20. The pressure sensor 51 is coupled to the tapping pressure sensor 24a, and is mainly used to detect the tapping force and the tapping speed on the pressure plate 20 performed by the user. The mouse main control circuit 53 is coupled to the pressure sensor 51, and is the main control circuit of the pressure sensing mouse 40. The mouse main control circuit 53 is configured to convert the detected tapping pressure, force, and speed into a control signal, which is able to be outputted. In practical applications, the mouse main control circuit 53 in the embodiment of the present disclosure may be a central computing unit (CPU) or a microcontroller in a mouse. In addition, in another embodiment, an analog-to-digital (AD) converter 52 is included between the pressure sensor 51 and the mouse main control circuit 53 in the main circuit board 50. In the embodiment, an input end of the analog-to-digital converter 52 is coupled to the pressure sensor 51, and an output end of the analog-to-digital converter 52 is coupled to the mouse main control circuit 53. The function of the analog-to-digital converter 52 is to perform an analog-to-digital signal converting operation on the pressure signal detected by the pressure sensor 51 so as to convert the pressure signal into a digital signal, and the digital signal is further provided to the mouse main control circuit 53 to generate a corresponding control signal.

In FIG. 4, the pressure level sensing element 54 is coupled to the mouse main control circuit 53, and the function of the pressure level sensing element 54 is to convert the control signal into a sensing signal and output the sensing signal. The coordinate corresponding screen object tapping element 55 is coupled to the pressure level sensing element 54 and configured to convert the sensing signal into a tapping action signal. Then, the pressure signal output 56 is coupled to the coordinate corresponding screen object tapping element 55 and is used to receive the tapping action signal and output the aforementioned mouse output signal to the software game in the computer. Then, the mouse output signal has a push-down effect on the object on the screen in the software game utilizing tapping force.

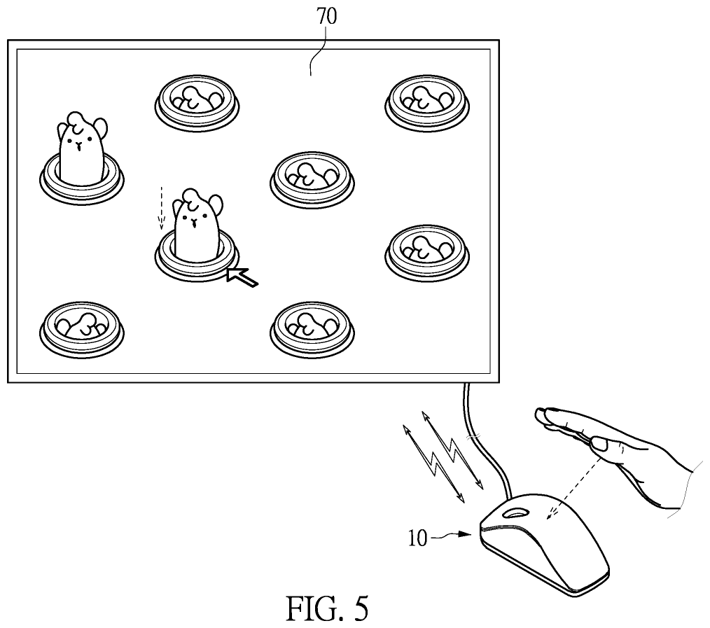

With reference to FIG. 5, FIG. 5 is a schematic diagram illustrating the operation of the pressure sensing mouse 10 in the present disclosure when the user plays a software game 70 utilizing tapping force. In practical applications, the software game 70 utilizing tapping force in the present disclosure can be a gopher game (as shown in FIG. 5), a soccer game, a basketball dribbling game, or other games that may require the user to apply a tapping force upon the pressure sensing mouse 10. The user uses the palm of a hand to press and apply force to operate the software game on the screen. In the gopher game, the target is a gopher. When the user taps the pressure plate 20, the tapping action on the pressure spring element 22 and the pressure sensing element 24 enables the tapping pressure sensor 24a and the pressure sensor 51 to detect the tapping force and the tapping speed on the pressure plate 20 being performed by the user, so that the corresponding object on the screen will be pressed down correspondingly. The object will be pressed by the tapping pressure on the pressure plate 20 at the proper time, speed, and force, so that the object will appear to be pressed down on the screen.

Moreover, in the present disclosure, the pressure sensing mouse 20 and the computer may be connected in a wireless communication manner, or may be connected in a wired connection manner. When the pressure sensing mouse 20 is connected to the computer in the wireless communication manner, a battery set is provided in the pressure sensing mouse. The battery set can provide the power required in the main circuit board 50, or can provide the power for the wireless communication when the wireless signal transmission is performed between the pressure sensing mouse 20 and the computer.

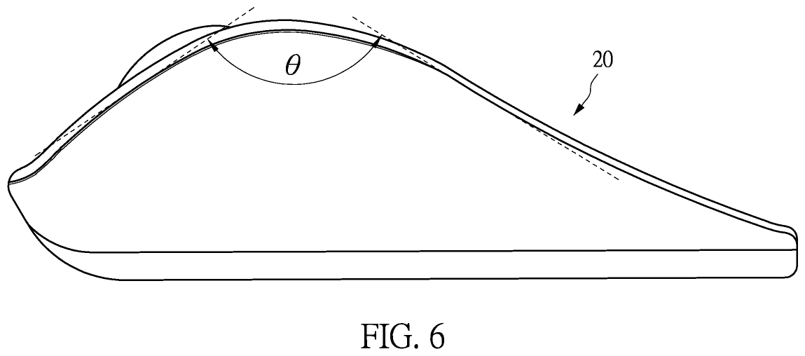

FIG. 6 is a diagram illustrating a structural shape between a front end and a rear end of the pressure plate 20 in the embodiment of the present disclosure.

From a lateral view, a curved structural shape is presented between the front end and the rear end of the pressure plate 20. An angle of the tangent to the curve can be manufactured to be between 160° and 100° in practical applications. The angle of the curved structure is a point of the pressure plate 20 pressed by the user, and the point is located at the top of the curved portion and is a center of the mass of the pressure plate 20 so as to prevent the pressure plate 20 from being easily damaged by the tapping actions. However, it should be noted that FIG. 6 is only an example for illustration, and the curved angle of the present disclosure in practical use would not be limited thereto.

In summary, the pressure plate 20 is implemented in the present disclosure, and the pressure plate 20 is the upper cover of the pressure sensing mouse 10 and is connected to the main circuit board 50 via the pressure sensor 24. The pressure sensing element 24 can detect the tapping force and the tapping speed of the pressure plate 20 performed by the user. When the magnitude and the speed of the pressure are correct, the object in the software game will appear to be pressed down. It is obvious that the technical content of the present disclosure includes significant patentable subject matter.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A pressure sensing mouse used in a software game utilizing tapping force, comprising:
a pressure plate including a pressure spring element extending downwardly from a center inside the pressure plate;
a main body disposed below the pressure plate and configured to carry the pressure plate, the main body having a left button switch, a right button switch, and a wheel, wherein the left button switch and the right button switch are disposed at a front side of the main body, and the wheel is disposed at the center of the front side;
a chassis disposed below the main body and configured to carry the main body;
a main circuit board disposed on the chassis and being a main control circuit of the pressure sensing mouse, the main circuit board being electrically connected to the left button switch and the right button switch and being configured to read an encoding information of the wheel; and
a pressure sensing element disposed on the main circuit board and electrically connected to the main circuit board, the pressure spring element penetrating the main body and contacting with the pressure sensing element;
wherein when the pressure sensing element detects a downward tapping action, a strength, and a speed of the pressure plate, the main circuit board correspondingly generates a mouse output signal and transmits the mouse output signal to a computer, and when the computer executes the software game utilizing tapping force and a user taps the pressure plate, an object on a screen of the software game utilizing the tapping force is correspondingly pushed down.

2. The pressure sensing mouse according to claim 1, wherein the main circuit board includes the control circuit for the left button switch, the right button switch, and the wheel, and further includes:
a tapping pressure sensor coupled to the pressure sensing element and configured to detect a tapping action performed on the pressure plate;
a pressure sensor coupled to the tapping pressure sensor and configured to detect a tapping strength and a tapping speed of the tapping action performed on the pressure plate;
a mouse main control circuit coupled to the pressure sensor and being a main control circuit of the pressure sensing mouse, and transforming the tapping pressure, strength and speed on the pressure plate into a corresponding control signal;
a pressure sensing element coupled to the mouse main control circuit and configured to convert and output the control signal into a sensing signal;
a coordinate corresponding screen object tapping element coupled to the pressure sensing element and configured to convert the sensing signal into a tapping action signal; and
a pressure signal output coupled to the coordinate corresponding screen object tapping element to receive the tapping action signal and output the mouse output signal, and the object in the software game utilizing tapping force is then controlled to be pushed down by the mouse output signal.

3. The pressure sensing mouse according to claim 2, wherein the main circuit board includes an analog-to-digital (AD) converter, and an input end of the AD converter is coupled to the pressure sensor and an output end of the AD converter is coupled to the mouse main control circuit, and wherein the AD converter is used to convert an analog signal into a digital signal for the mouse main control circuit.

4. The pressure sensing mouse according to claim 1, wherein a structure with a curved shape from a lateral view is formed between a front end and a rear end of the pressure plate, and an angle of the structure with the curved shape is between 100 degree and 160 degree.

5. The pressure sensing mouse according to claim 1, wherein the pressure sensing mouse and the computer is connected in a wireless connection manner.

6. The pressure sensing mouse according to claim 1, wherein the pressure sensing mouse and the computer is connected in a wired connection manner.

7. The pressure sensing mouse according to claim 1, wherein the software game utilizing tapping force is a gopher game, a soccer game, or a basketball dribbling game.

8. The pressure sensing mouse according to claim 5, wherein a battery set is installed in the pressure sensing mouse to provide a power for the main circuit board or provide a power for wireless connection, so that a wireless signal is capable of being transmitted between the pressure sensing mouse and the computer.

9. The pressure sensing mouse according to claim 1, wherein the left button switch and the right button switch are elastic switch elements, the left button switch contacts a bottom at a left front end of the pressure plate and the right button switch contacts the bottom at a right front end of the pressure plate, so that the left front end and the right front end of the pressure plate have functions of left and right buttons of a mouse.
